(19) United States
(12) Patent Application Publication
(10) Pub. No.: US 2026/0065910 A1
(43) Pub. Date: Mar. 5, 2026

(54) System

(71) Applicant: Softbank Group Corp., Tokyo (JP)

(72) Inventor: Toru Yoshioka, Tokyo (JP)

(21) Appl. No.: 19/317,239

(22) Filed: Sep. 3, 2025

(30) Foreign Application Priority Data
Sep. 4, 2024 (JP) 2024-152627

(51) Int. Cl. G10L 15/22; G06F 40/166; G10L 13/02

(52) U.S. Cl. CPC G10L 15/22; G06F 40/166; G10L 13/02; G10L 2015/223

(57) ABSTRACT

A system includes a processor that is configured to acquire a voice command from a user, analyze the acquired voice command, acquire screen information based on the analyzed voice command, process the acquire screen information using a generative artificial intelligence model to summarize or edit the information, and provide the summarized or edited information to the user as synthesized speech.

### CROSS-REFERENCE TO RELATED APPLICATION

This application is based on and claims priority under 35 USC 119 from Japanese Patent Application No. 2024-152627 filed on September 4, 2024, the disclosure of which is incorporated by reference herein.

### BACKGROUND

### TECHNICAL FIELD

The present disclosure relates to a system.

### RELATED ART

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Visually impaired individuals often face significant barriers in efficiently acquiring information displayed on electronic device screens and performing text input or editing operations. Conventional systems for voice-based operation are limited in their ability to provide concise summaries of complex screen content, execute flexible text editing, or support comprehensive email creation and confirmation through intuitive voice commands. As a result, visually impaired users may experience reduced independence and productivity when interacting with digital environments.

### SUMMARY

To address these issues, the present invention provides a system comprising a processor configured to acquire and analyze voice commands from a user, obtain relevant screen information, and utilize a generative artificial intelligence model to summarize or edit the content as necessary. The system further enables transcription or editing of text and facilitates comprehensive email creation, confirmation, and sending based on the user's voice commands. The summarized or edited information is delivered to the user through synthesized speech, thereby allowing visually impaired individuals to efficiently access information and manage text-based tasks using intuitive voice-based interactions.

“Processor” means a hardware device or combination of hardware and software capable of executing instructions and performing operations as specified in the system.

“Voice command” means an instruction or request issued by a user in spoken language, which is intended to be recognized and acted upon by the system.

“Analyze” means to process, interpret, and determine the intent or content of acquired data, such as a voice command.

“Screen information” means data, including text and images, which is currently displayed or accessible on an electronic device display.

“Generative artificial intelligence model” means a software-based system, including neural network architectures or similar machine learning models, capable of generating, summarizing, or editing content based on input data.

“Summarize” means to extract and condense the most important points or main ideas from a body of information.

“Edit” means to change, modify, or manipulate text or other data as instructed by the user or as required by the system operation.

“Synthesized speech” means artificial audio output generated from textual or structured data using text-to-speech technology, which is presented to the user as spoken language.

“Transcribe” means to convert spoken language or audio content into written text.

“Email” means an electronic message composed of at least a subject and a body, intended for digital communication between users.

“Confirm” means to present composed or edited content to the user for verification or approval before proceeding with a further action, such as sending an email.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

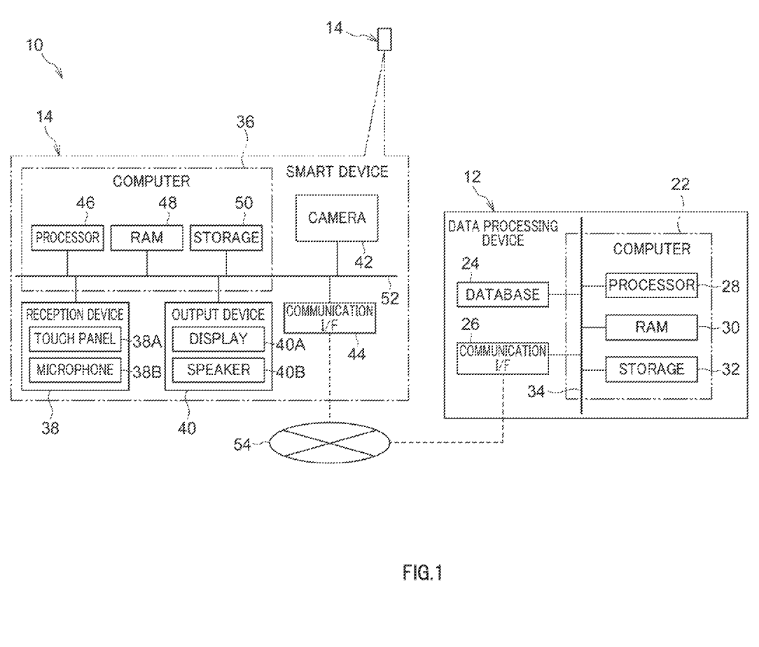

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

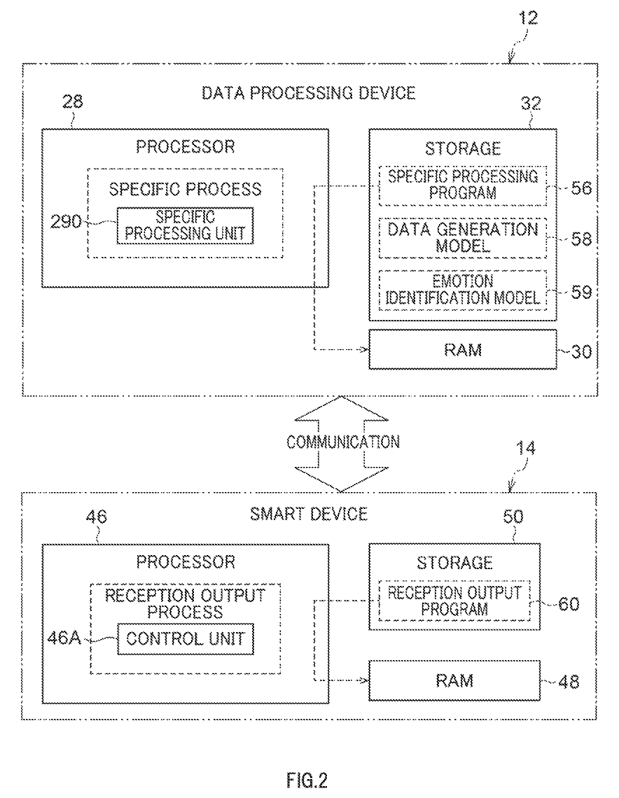

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Visually impaired users and other individuals with limited ability to interact with visual display devices encounter significant challenges in efficiently obtaining, processing, and acting upon information presented on device screens. Conventional user interfaces that rely on direct visual interaction or basic audio feedback are inadequate when performing complex operations such as summarizing content, editing text, or composing and transmitting communication. There exists a need for an improved system that enables seamless, efficient, and accurate operation of information processing devices by such users through natural language voice commands.

The specific processing by the specific processing unit 290 of the data processing device 12 in Example 1 is realized by the following means.

The present invention provides a server comprising a processor configured to acquire and convert audio input into digital information, analyze and interpret user instructions from the converted information, obtain and extract character data from image information according to the instructions, utilize a generative information processing model to summarize or edit the extracted character data by generating input prompts, and output the resulting information in an audio format to the user. This enables visually impaired users to efficiently acquire, process, and act upon information displayed on devices through natural language voice commands, thereby improving accessibility, usability, and independence.

The term “audio input information” refers to information derived from user speech or sounds that is received through an input device such as a microphone.

The term “digital information” refers to data that represents audio, text, or image signals in a machine-readable, electronic format.

The term “user instruction content” refers to the meaning, intent, or directive expressed by a user in the audio input information.

The term “image information” refers to visual data captured from a display or environment, such as screen captures, photographs, or other graphical representations.

The term “character information” refers to alphanumeric symbols or text data that are extracted from image information or generated as a result of audio or text processing.

The term “generative information processing model” refers to an artificial intelligence model capable of analyzing, generating, or transforming information, including summarization and editing, in response to given input data.

The term “input sentence for the generative information processing model” refers to a textual prompt or instruction supplied to the generative information processing model to specify the desired information processing task.

The term “audio output information” refers to data that is processed by a system and presented to a user as synthesized speech or other audible signals.

The term “communication information” refers to messages or data generated for the purpose of exchanging information with other users, systems, or devices, including emails, notifications, or other transmissions.

The term “control process” refers to a sequence of operations executed by the processor for managing, editing, or facilitating information processing tasks in accordance with user instruction content.

A representative embodiment of the invention may be realized through a system including a processor that interacts with at least one user interface device (terminal), and a central processing server connected via a communication network. The terminal is equipped with essential hardware components such as a microphone, display, network communication module, and speaker, and is capable of executing software for speech recognition, screen capture, optical character recognition (OCR), and text-to-speech synthesis. The server is implemented on a general-purpose computing device, and executes software for advanced data processing, including natural language processing and artificial intelligence-based information generation.

The user operates the terminal by providing an audio input, such as a voice command, through the microphone. The terminal uses speech recognition software, for example, a general-purpose speech-to-text API, to convert the user's voice command into digital text data. The terminal then transmits this text data to the server via network communication, such as an HTTPS connection.

The server receives the text data and analyzes it with natural language processing techniques, using models such as a neural network-based speech recognition system, to extract the intent and content of the command. If the user requests information related to content displayed on the terminal, the server instructs the terminal to acquire screen image information.

The terminal captures the current display using its screen capture function. Optical character recognition software, for example, a widely available OCR engine, is applied to the captured image to extract text data from the image information. The extracted text is transmitted from the terminal to the server for further processing.

The server processes the extracted text using a generative artificial intelligence model, such as a large language model with content summarization and editing capabilities. The server constructs a prompt sentence based on the user’s request and supplies it together with the extracted text to the generative AI model. The AI model analyzes the input and outputs a concise summary or edited version of the content according to the original user instruction.

As a concrete example, when the user gives an audio command such as “Summarize this page,” the system performs the following operations:

1. The terminal captures the audio command via the microphone and transcribes it using speech recognition software.

2. The text of the command is transmitted to the server, which analyzes and identifies the intent as "summarization of displayed content."

3. The terminal captures the screen and extracts text using an OCR engine.

4. The server supplies the extracted text and the following prompt sentence to the generative AI model:

Summarize the following web page for a visually impaired user: [extracted text]

5. The summary returned by the AI model is transmitted to the terminal.

6. The terminal uses text-to-speech software, for example, a general-purposed text-to-speech API, to convert the summary into audio and plays it for the user through its speaker.

As another example, when the user instructs, “Create a new email with the subject ‘Work Report’ and the body ‘Today I submitted my work report,’” the server parses the recognized command, identifies email parameters, and generates a draft using the following prompt sentence to the generative AI model:

Draft a professional email with the subject 'Work Report' and body 'Today I submitted my work report.'

The terminal then plays back the draft using text-to-speech and, upon user confirmation, the server sends the email.

Through this embodiment, the system enables visually impaired users or other individuals to efficiently operate device functions, obtain information, create and transmit communications, and interact naturally with information processing devices using only their voice. The realization of this embodiment employs standard computing devices, widely available user interface hardware, and established software components, ensuring practical implementation and scalability.

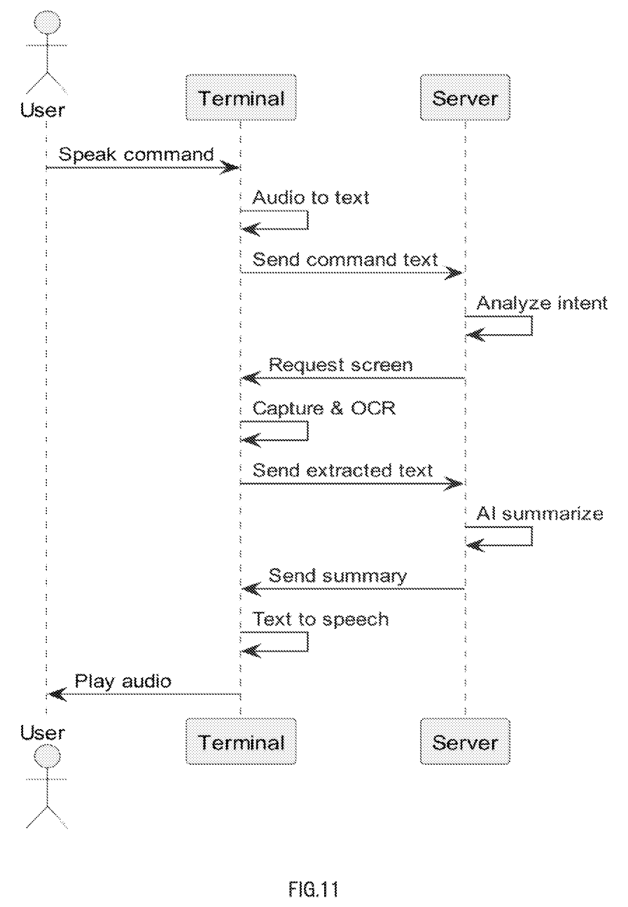

The following describes the processing flow using FIG. 11.

### Step 1:

User provides a voice command by speaking into the microphone of the terminal.

Input: User’s natural voice command.

Output: Analog audio signal captured by the terminal’s microphone.

Specific action: User says, for example, “Summarize this page.”

### Step 2:

Terminal converts the analog audio signal into digital audio data using its built-in audio processing hardware.

Input: Analog audio signal.

Output: Digital audio file (such as WAV format).

Specific action: Terminal samples the audio signal and creates a digital file representing the user's spoken words.

### Step 3:

Terminal applies speech recognition software to the digital audio data to generate a text transcript.

Input: Digital audio file.

Output: Text data representing the user’s command.

Specific action: Terminal sends audio data to a speech-to-text API or a local recognition engine, which processes the data and returns a text string such as “Summarize this page.”

### Step 4:

Terminal transmits the recognized text command to the server over a secure network connection.

Input: Text data containing user’s command.

Output: Command data delivered to the server.

Specific action: Terminal packages the command in a communication protocol (e.g., HTTPS POST) and sends it to the server.

### Step 5:

Server analyzes the received text command using natural language processing to determine the user’s intent.

Input: Text command from terminal.

Output: Interpretation of user intent (such as “summarize screen content”).

Specific action: Server applies parsing and intent recognition algorithms to detect keywords and the type of requested operation.

### Step 6:

Server sends an instruction to the terminal to capture the current screen and extract image information.

Input: Interpretation of user intent.

Output: Instruction message for screen capture.

Specific action: Server generates and sends a command message to the terminal, specifying the need for a screenshot and further processing.

### Step 7:

Terminal captures a screenshot of the current screen using the operating system’s screen capture functionality.

Input: Instruction from server.

Output: Screen image file (such as PNG or JPEG).

Specific action: Terminal calls an OS-level function to obtain a digital image representing what is currently displayed.

### Step 8:

Terminal applies optical character recognition (OCR) to the screen image file to extract textual information.

Input: Screen image file.

Output: Extracted text data.

Specific action: Terminal runs OCR software on the image, converting visible text in the image into machine-readable text.

### Step 9:

Terminal sends the extracted text data to the server for further processing.

Input: Extracted text data from OCR.

Output: Text data delivered to the server.

Specific action: Terminal uses a communication protocol to transmit the textual content to the server.

### Step 10:

Server generates a prompt sentence for the generative AI model, supplying the extracted text and formulating the desired task.

Input: Extracted text data and user intent.

Output: Prompt sentence for the generative AI model.

Specific action: Server constructs a sentence such as “Summarize the following web page for a visually impaired user: [insert extracted text here].”

### Step 11:

Server processes the prompt and the extracted text using a generative AI model to produce a summary or edited text.

Input: Prompt sentence and textual data.

Output: Generated summary or edited text.

Specific action: Server submits the prompt and text to the AI model, which returns a concise summary or edited version.

### Step 12:

Server sends the summary or edited text to the terminal.

Input: Generated summary or edited text from AI model.

Output: Summary or edited text delivered to the terminal.

Specific action: Server transmits the processed result via secure communication to the terminal.

### Step 13:

Terminal synthesizes speech from the summary or edited text using text-to-speech software.

Input: Summary or edited text.

Output: Generated audio output file or stream.

Specific action: Terminal uses a text-to-speech API or engine to convert the provided text into audio.

### Step 14:

Terminal outputs the synthesized audio through its speaker to the user.

Input: Audio file or stream from text-to-speech conversion.

Output: Audible speech presented to the user.

Specific action: Terminal plays the audio output so that the user can hear the requested information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Visually impaired users face significant challenges when performing electronic transactions or processing information on devices with visual displays, as they have difficulty accurately understanding screen information and editing text. These difficulties are particularly pronounced in procedures that require confirmation, input, or editing of information, causing inefficiency and increasing the risk of errors. Conventional assistive solutions are often limited to basic screen reading or textual conversion, lacking context awareness, adaptability to user emotions, and robust interactive capabilities for complex operations such as payment, document composition, and communication. Accordingly, there is a need for a system that enables visually impaired users to intuitively operate device functions and obtain essential information by voice, with intelligent support adapted to the user’s instructions and emotional condition.

The specific processing by the specific processing unit 290 of the data processing device 12 in Application Example 1 is realized by the following means.

The present invention provides a server comprising a processor configured to acquire acoustic information from a user, convert the acoustic information into linguistic information and interpret command content, acquire visual display information based on the interpreted command content, extract character information using optical character recognition technology, generate a prompt sentence for a generative artificial intelligence model based on the extracted character information and command content, input the prompt sentence into the generative artificial intelligence model to create summary or edited information, convert the generated information into acoustic information, and provide it to the user via an auditory output device, while also estimating the user’s emotional state from the acoustic information and adjusting the output content or expression method accordingly. This enables visually impaired users to perform complex electronic operations using voice commands, receive adaptive and context-aware feedback tailored to their emotional state, and efficiently execute tasks such as payments, text editing, and communication on electronic devices.

The term “acoustic information” refers to sound data, including voice input, that is captured from a user through an audio input device such as a microphone.

The term “linguistic information” refers to textual data derived from converting acoustic information, typically representing recognized spoken words or commands in a text-based format.

The term “command content” refers to the operational intent or instruction extracted from linguistic information, indicating the user’s desired action or request.

The term “visual display device” refers to any electronic device capable of presenting graphical or textual information to a user, including but not limited to screens, monitors, or display panels.

The term “display information” refers to data that is presented visually on a visual display device, such as user interfaces, graphical elements, or textual content.

The term “optical character recognition technology” refers to methods or systems that automatically detect and convert textual characters within images or display information into machine-readable text.

The term “character information” refers to textual data extracted from display information using optical character recognition technology.

The term “prompt sentence” refers to a structured natural language instruction or query generated for input into a generative artificial intelligence model to guide its processing and output.

The term “generative artificial intelligence model” refers to a computational system or algorithm trained on large-scale data that is capable of generating, summarizing, or editing natural language output based on provided input.

The term “summary information” refers to condensed textual data that presents the essential content or meaning of more extensive information.

The term “edited information” refers to content that has been modified, rearranged, or otherwise processed to fulfill a user’s command or intent.

The term “auditory output device” refers to hardware, such as speakers or headphones, capable of presenting audio information to a user.

The term “emotional state” refers to the psychological or affective condition of the user as estimated from features of their acoustic information, such as tone, pitch, or speech patterns.

The term “expression method” refers to the manner, style, or adaptation of content presentation, especially as adjusted in response to the estimated emotional state of the user.

The term “recording area” refers to a specific memory region or storage area within an electronic device, where data such as character information can be saved, copied, or edited.

The term “electronic communication document” refers to any form of digital message, including emails or electronic texts, intended for transmission to another party through a communication network.

An embodiment of the present invention can be realized as a system comprising a server, a terminal, and a user interface, each configured to interact as described below.

The terminal is provided with an audio input device such as a microphone, a visual display device such as a touch screen, a processing unit such as a mobile device processor, speakers or audio output devices, and internal or external network communication means. The server comprises a processor, memory, network interface, and software for command interpretation and artificial intelligence processing.

The user operates the system by speaking a command (for example, "Start payment," "Summarize this page," or "Create a new email") into the microphone of the terminal. The terminal captures the user's acoustic information and processes it using speech recognition software. A typical implementation can use cloud-based speech recognition platforms such as a generic cloud speech-to-text service.

The terminal sends the transcribed linguistic information to the server via a secure network connection. The server receives the command content and interprets the operational intent using natural language processing libraries, such as a general-purpose NLP library or a custom rule-based parser.

Based on the interpreted command, the server requests specific screen or display information from the terminal. The terminal then captures an image of the current visual display (such as through a screenshot API) and applies optical character recognition software, such as an open-source OCR engine for extracting character information.

The terminal returns the extracted character information to the server. The server combines the command content and the extracted character information to generate a prompt sentence suitable for a generative artificial intelligence model, such as a large language model. The prompt sentence is then issued to the generative AI model, for example, a model hosted on the server or a cloud-based AI platform.

The generative AI model produces summary information or edited information in natural language. The server receives the AI output and adjusts the information depending on any detected emotional state of the user. For emotion estimation, the server analyzes characteristics of the original acoustic information (for example, prosody, speed, volume) using an emotion recognition model implemented on the server.

After adapting the content to the user’s intent and emotional state, the server or terminal uses text-to-speech software, such as a cloud-based or device-native text-to-speech engine, to synthesize the AI-generated response into acoustic information. The terminal then outputs this information using audio hardware, such as speakers.

In specific implementations, the processor may be further configured to copy or edit character information based on the command, or to execute the creation, confirmation, and transmission of an electronic communication document such as an email, according to user instructions.

For example, when performing a payment transaction, the user may say, "Start payment." The terminal transcribes the command and sends it to the server. The server requests screen data, and the terminal extracts "Product: ABC, Price: 3000 yen" from the display using OCR. The server then constructs a prompt sentence such as:

Product: "ABC", Price: 3000 yen. Please create a payment confirmation sentence suitable for a visually impaired user.

The generative AI model returns: Would you like to pay 3000 yen for the product 'ABC'? Please say 'confirm' to proceed.

The system then converts this into audio and plays it to the user for confirmation.

In another case, for summarizing a web page, the server can generate a prompt such as:

Summarize this information as simply and quickly as possible. The user is in a hurry: [screen data]

The AI model produces a tailored, abbreviated summary, which is converted to speech and presented in an appropriate tone for the user’s emotional state.

For email composition, if the user states, "Create a new email. Subject: Work report. Body: Today I completed all my tasks," the server may generate a prompt such as:

The user wants to create an email with subject "Work report" and body "Today I completed all my tasks." Please generate confirmation text for this.

After the AI model provides the confirmation text, the system reads it aloud and waits for the user's command, such as "Send," to transmit the message.

By utilizing commercially available or open-source speech recognition, optical character recognition, text-to-speech, emotion recognition, and generative artificial intelligence software modules, the system enables visually impaired users to perform electronic transactions, information processing, and communication efficiently and intuitively through voice interaction.

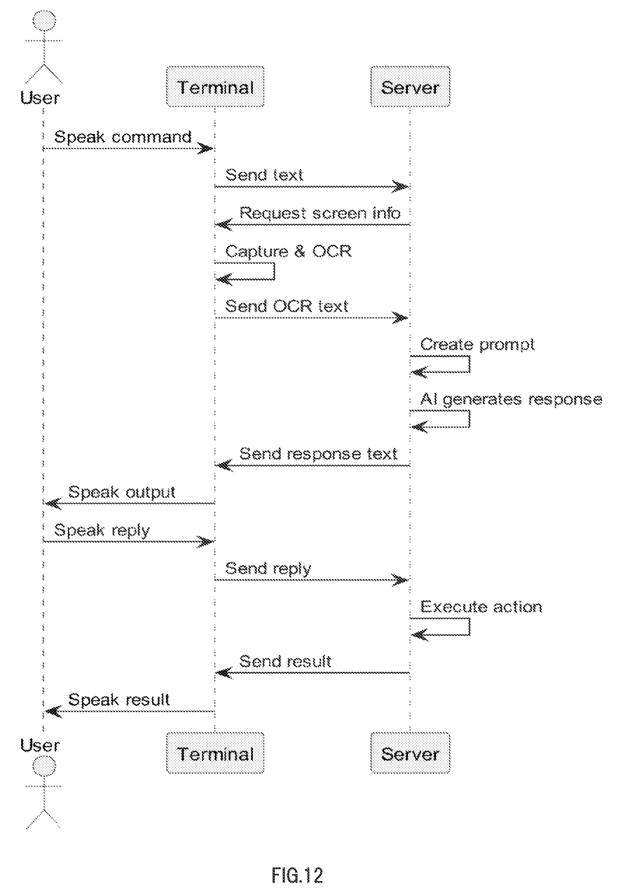

The following describes the processing flow using FIG. 12.

### Step 1:

User speaks a command, such as "Start payment" or "Summarize this page," into the microphone of the terminal.

Input: Spoken voice command from the user.

Output: Audio data (captured voice signal).

Specifically, the user activates the application and issues a clear, natural language command for the desired operation.

### Step 2:

Terminal receives the audio data from the microphone and processes it using speech recognition software.

Input: Audio data (voice signal).

Output: Text data (recognized command).

The terminal submits the audio data to a speech recognition module, which analyzes sound features and generates a textual representation of the spoken command, such as "Start payment."

### Step 3:

Terminal sends the recognized command as text to the server over a secure network connection.

Input: Text data (recognized command).

Output: Data packet transmitted to the server.

The terminal structures the text with metadata (user ID, timestamp) and initiates a data transmission to the server endpoint for further processing.

### Step 4:

Server receives the command text and uses a command parser to determine the user's intent.

Input: Command text.

Output: Interpreted operational intent (for example, "initiate payment").

The server analyzes the received data, applies natural language processing to classify the type of operation, and generates an internal process instruction.

### Step 5:

Server sends a request to the terminal to obtain the current screen display information.

Input: Internal instruction (request for visual data).

Output: Request transmitted to the terminal.

The server formats and dispatches a command to the terminal, specifying that up-to-date screen content or application interface data should be captured.

### Step 6:

Terminal captures a screenshot of the display and processes the image using optical character recognition (OCR) software.

Input: Display image (screenshot).

Output: Extracted textual information (screen content in text form).

The terminal saves an image of the current screen, starts the OCR software, and detects and extracts relevant text, such as product names and prices.

### Step 7:

Terminal sends the extracted text data to the server.

Input: Extracted text (screen information).

Output: Data packet containing screen text, transmitted to the server.

The terminal compiles the OCR results, associates required context, and sends the structured data to the server.

### Step 8:

Server receives the extracted text and creates a prompt sentence using both the interpreted user command and the screen data.

Input: User intent and screen textual information.

Output: Prompt sentence for a generative AI model.

The server combines the command context (e.g., "Start payment") with the screen data (e.g., "Product: ABC, Price: 3000 yen") into a natural language prompt, such as "The user wants to pay for item 'ABC' at 3000 yen. Please generate a confirmation message suitable for an auditory interface."

### Step 9:

Server inputs the prompt sentence to a generative AI model and receives summary or edited information as output.

Input: Prompt sentence.

Output: Summary text or edited response.

The server interacts with the generative AI model by submitting the prompt and collects the returned result—for example, "Would you like to pay 3000 yen for product 'ABC'? Please say 'confirm' to proceed."

### Step 10:

Server analyzes the user's original audio data to estimate the user's emotional state using an emotion recognition module.

Input: User's audio data.

Output: Estimated emotional state (e.g., urgency, neutrality).

The server uses algorithms to examine features such as tempo, pitch, and volume in the user's voice, outputting an emotional status tag.

### Step 11:

Server adjusts the output content or style according to the estimated emotional state.

Input: AI-generated text and emotional state tag.

Output: Adaptive confirmation or instruction text.

The server modifies the message's length, formality, or reassurance level based on detected emotions (e.g., making instructions simpler if urgency is detected).

### Step 12:

Server or terminal converts the final confirmation or instruction text into synthesized audio using text-to-speech software.

Input: Final output text.

Output: Synthesized audio file.

The processor runs the output text through a text-to-speech engine, generating audio, and sends it to the terminal if synthesis is server-side.

### Step 13:

Terminal outputs the synthesized audio to the user using the speaker.

Input: Synthesized audio file.

Output: Audible prompt or confirmation message.

The terminal plays the audio so the user hears, for example, "Would you like to pay 3000 yen for product 'ABC'? Please say 'confirm' to proceed."

### Step 14:

User replies with a voice command, such as "Confirm."

Input: Audible prompt from the system.

Output: Spoken response from the user.

The user listens and vocalizes their chosen reply, which is picked up by the terminal, and this initiates a new cycle starting from step 2.

### Step 15:

If the reply involves executing an action (such as payment or sending an email), the terminal captures and transcribes the command and sends it to the server, which then processes the execution.

Input: User's confirmed instruction (e.g., "Confirm").

Output: Action performed (e.g., payment processing, confirmation sent, document transmitted).

The server interprets the reply and interacts with external APIs as needed (for example, a payment gateway or email service), ultimately updating the user via synthesized audio with the result, such as "Your payment has been completed."

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventionally, systems for assisting visually impaired users in operating devices and obtaining information mainly rely on voice command recognition and standard information output. However, these systems are insufficient in adjusting their responses and information presentation according to the user's emotional state, leading to situations where users may feel frustration or are unable to obtain information efficiently and comfortably. Therefore, it is necessary to provide a system that can interpret the user's emotions from voice input and adapt the form or content of information provision, thereby significantly improving usability and user confidence during device operation.

The specific processing by the specific processing unit 290 of the data processing device 12 in Example 2 is realized by the following means.

The present invention provides a server comprising an acoustic information acquisition module, a command analysis module, an emotion recognition module, an image information acquisition module, an optical character recognition module, and a generative machine learning module, wherein the processor is configured to convert acoustic information to character information, extract command content and user emotional state, obtain and process display content as character information, and summarize or edit the information in an adaptive manner before presenting it acoustically to the user based on the recognized emotional state. This enables the system to provide information and support that are dynamically tailored to the user's emotional state, thereby enhancing efficiency, comfort, and confidence for visually impaired users utilizing information devices.

The term “acoustic information” refers to audio data acquired from a user, including spoken commands, utterances, and vocal expressions.

The term “character information” refers to textual data obtained by converting acoustic information or extracting text from image information using analysis techniques.

The term “acoustic analysis technology” refers to methods or processes that analyze audio data and convert it into textual data.

The term “command content” refers to the meaning or instruction understood from the user's spoken input after conversion into character information.

The term “image information” refers to digital data representing the visual content displayed on a device, such as screenshots or captured display images.

The term “display device” refers to any electronic hardware capable of visually presenting information to a user, including screens of computers, tablets, or mobile devices.

The term “optical character recognition technology” refers to software or algorithms that analyze image information and identify and extract text contained within those images.

The term “emotional state” refers to an inferred psychological condition of the user, such as calmness, frustration, stress, or urgency, determined by analyzing acoustic information.

The term “generative machine learning model” refers to a machine learning system that processes input data and autonomously produces output data, such as summarized or edited text, according to specific criteria or user context.

The term “summarization” refers to the process of condensing lengthy or detailed information into a more concise format that retains the most important points.

The term “content editing” refers to the modification, rephrasing, or restructuring of textual data according to user instructions or contextual requirements.

The term “acoustic output device” refers to hardware designed to deliver synthesized audio or speech output to a user, such as speakers or headphones.

The term “electronic communication message” refers to a digitally constructed and transmitted message, such as an email, which can include a subject line and body content.

This invention can be implemented by constructing a system that interacts between a server and a terminal operated by a user, preferably a visually impaired user. The system incorporates both hardware and software components to analyze and process acoustic and visual data, enabling adaptive voice-guided support according to the user's emotional state.

The terminal may be realized using general-purpose portable electronic devices such as smartphones, tablets, or computers equipped with a microphone, display, speaker, or headphones. The server is implemented using one or more general-purpose computational devices with access to network resources and capable of executing advanced data processing algorithms.

The terminal acquires acoustic information, such as the user's spoken command, via a built-in microphone. The terminal converts this voice input to a digital audio file (for example, WAV or MP3 format) and may use an audio recognition program (such as a general-purpose voice recognition API) to generate textual data from the audio input.

The terminal transmits the voice data and/or preliminary textual data to the server through a secure network protocol such as HTTPS. The server receives the acoustic information and uses additional speech recognition technology, such as a cloud-based speech-to-text engine, to enhance accuracy. The server then performs emotion analysis using emotion recognition software (for example, a tone analyzer) that assesses vocal properties such as pitch, speed, and intonation to infer the user's emotional state.

Based on the transcribed command, the server instructs the terminal to acquire image information of the current display content, for example, by capturing a screenshot of the display. The terminal applies optical character recognition (OCR) software—such as Tesseract OCR—to the captured image to extract character information.

The extracted text, along with data representing the user's emotional status, is sent to the server. The server constructs a prompt sentence for a generative AI model (for example, a large language model) to perform summarization or content editing of the received textual data. The generative AI model receives a prompt that includes the user’s emotion and a specific instruction, such as providing concise information when the user is frustrated.

For instance, the server may generate the following prompt sentence for the generative AI model:

"Act as an assistant for a visually impaired user. The user just said 'Summarize this page,' and the detected emotional state is urgent or frustrated. Carefully and politely provide a very brief and clear summary of the following text: [insert OCR-extracted text here]"

The summary or the edited information produced by the generative AI model is returned to the terminal, which uses a text-to-speech engine (for example, a text-to-speech module) to convert the summary into synthesized voice output. The terminal presents this information to the user through its speaker or headphones and may provide additional confirmation via haptic or visual signals.

As a specific example, when a visually impaired user speaks "Please summarize this page" to a smartphone, the terminal records the command and transmits it to the server. The server determines the user is in a hurry, processes the screen information to OCR, and employs a generative AI model to create a concise summary, which is then read aloud by the terminal’s synthesized speech function.

The system can also perform editing or e-mail functions according to further user commands. For example, when instructed to "Copy this summary and paste it in an email," the system edits the document and prepares draft e-mails, enabling communication support for the visually impaired user.

By integrating audio acquisition modules, optical character recognition technology, emotion recognition software, and a generative AI model, the invention allows for dynamic adjustment of guidance and information presentation, ensuring efficient and comfortable support that is contextually appropriate to the user's emotional needs.

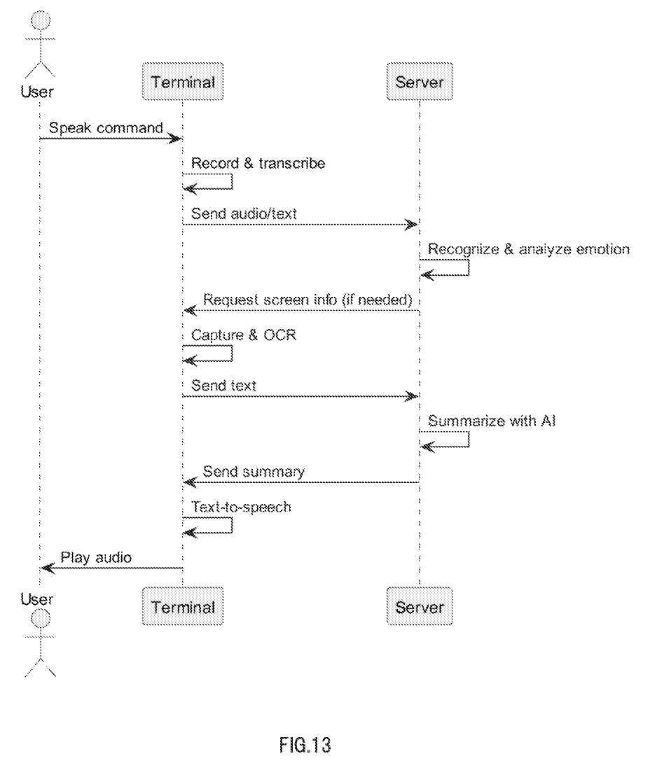

The following describes the processing flow using FIG. 13.

### Step 1:

The user speaks a voice command, such as "Summarize this page," into the microphone of the terminal.

Input: User's spoken command.

Output: Analog voice signal.

The terminal receives the analog voice signal as input and prepares to record the user's command.

### Step 2:

The terminal records the analog voice signal and digitizes it into an audio file format such as WAV or MP3.

Input: Analog voice signal.

Output: Digital audio data.

The terminal uses its built-in hardware to sample the analog signal and creates a digital audio file for subsequent processing.

### Step 3:

The terminal uses a voice recognition software module to convert the audio data to text.

Input: Digital audio data.

Output: Recognized text data.

The terminal calls a speech recognition API, transmitting the audio data as input and receiving the recognized text of the command as output.

### Step 4:

The terminal transmits the digital audio data and/or text data to the server via a secure network protocol such as HTTPS.

Input: Digital audio data and/or recognized text data.

Output: Data packet sent to the server.

The terminal packages the audio and text data in a secure message and sends it over the network to the server.

### Step 5:

The server receives the audio and/or text data and performs an additional speech recognition process if needed.

Input: Audio data and/or text data.

Output: Verified and finalized text data.

The server may use a cloud-based speech-to-text engine to improve accuracy, processing the input and outputting the finalized recognized command text.

### Step 6:

The server performs emotion analysis on the audio data using an emotion recognition module.

Input: Audio data.

Output: Emotion state data.

The server applies emotion analysis algorithms to the acoustic features, such as pitch and tempo, and infers the user's emotional state (e.g., "frustrated" or "calm").

### Step 7:

The server parses the command text and, if necessary, instructs the terminal to capture its current screen and obtain the display contents as an image.

Input: Command text and emotion state data.

Output: Instruction to terminal for screen capture.

The server sends a command specifying to capture and process the display for OCR.

### Step 8:

The terminal captures a screenshot of its display and applies an OCR software module to extract text from the image.

Input: Display image (screenshot).

Output: Extracted screen text data.

The terminal processes the screenshot through an OCR engine, such as Tesseract, and generates the text data from the display content.

### Step 9:

The terminal sends the extracted text data to the server through a secure protocol.

Input: Screen text data.

Output: Data packet sent to the server.

The terminal formats the screen text data and uploads it as a secured message to the server.

### Step 10:

The server constructs a prompt sentence, referencing the user's detected emotional state, and passes the prompt and screen text data to a generative AI model for summarization or content editing.

Input: Screen text data and emotion state data.

Output: Summary text or edited content.

The server generates a prompt such as, "Summarize the following for a user who is frustrated," sends the input to the generative AI model, and receives the output summary or edited content.

### Step 11:

The server sends the summary or edited text result to the terminal.

Input: Summary text or edited content.

Output: Data packet sent to the terminal.

The server encodes and transmits the information securely to the terminal for presentation.

### Step 12:

The terminal receives the summarized or edited text and applies a text-to-speech engine to synthesize voice audio from the text.

Input: Summary text or edited content.

Output: Synthesized voice audio data.

The terminal processes the text with a speech synthesis module, such as a text-to-speech engine, producing voice output.

### Step 13:

The terminal plays the synthesized voice audio to the user through its speaker or headphones.

Input: Synthesized voice audio data.

Output: Audible information delivered to the user.

The terminal activates its acoustic output device to present the information to the user in an accessible auditory format.

### Step 14:

If the user issues further voice commands, such as editing text or creating an email, the process repeats as described: the terminal captures the command and sends it to the server for interpretation and execution, leveraging AI-based content handling as needed.

Input: Subsequent user command.

Output: Executed action (e.g., edited text, prepared email, confirmation prompt).

The user interacts with the system in a conversational loop, allowing for continuous tailored support.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional navigation and information provision systems for users with visual impairments in physical stores often lack consideration of the user's emotional state and may not provide sufficient, adaptive guidance regarding the location of goods or in-store navigation. As a result, users experiencing negative emotions such as anxiety or frustration may find it difficult to complete shopping tasks efficiently and comfortably. There is a need for an improved system that can recognize a user's emotional state and dynamically tailor information and navigation instructions to the user's needs and current mood.

The specific processing by the specific processing unit 290 of the data processing device 12 in Application Example 2 is realized by the following means.

The present invention provides a server comprising a processor configured to acquire acoustic information from a user, analyze the acoustic information to generate command information, estimate an emotional state based on the command information and acoustic feature information by an emotion analysis device, adjust the information providing method according to the estimated emotional state using a control device, acquire image information based on the command information, convert the acquired image information into character information, generate guidance information based on the converted character information and position information using a generative artificial intelligence model, and provide the guidance information and guidance method as acoustic information to the user. This enables real-time delivery of adaptive navigation guidance and information that takes into account the user's emotional state, thereby improving accessibility and user experience for visually impaired persons in physical stores.

The term “acoustic information” refers to sound data, including spoken voice and other audio signals, acquired from a user via an input device such as a microphone.

The term “command information” refers to data representing a user’s intent or instructions, which are derived by analyzing the user's acoustic information.

The term “acoustic feature information” refers to characteristics of the acquired sound data, such as tone, pitch, speed, and intonation, which may reflect the emotional state of the user.

The term “emotion analysis device” refers to hardware or software configured to estimate or determine the emotional state of a user based on analysis of command information and acoustic feature information.

The term “control device” refers to hardware or software configured to modify or adjust the method and style of information provision according to the user’s estimated emotional state.

The term “image information” refers to visual data, such as images or video captured from a camera or other imaging device, which may contain environmental or product-related information.

The term “character information” refers to text data extracted from image information, typically through optical character recognition or similar processing.

The term “guidance information” refers to instructions or directions generated for the user, such as navigation information, based on character information and position information.

The term “position information” refers to data identifying a location or spatial coordinates within a given environment, such as a physical store.

The term “generative artificial intelligence model” refers to a computational model or algorithm that is capable of generating, editing, or summarizing information in response to input data, such as user intent and environmental context.

The term “acoustic information to the user” refers to the provision of processed guidance and instruction data back to the user in audio format, utilizing an output device such as a speaker or earphone.

The term “electronic record information” refers to any digital data, document, or content that can be created, edited, or transcribed in response to user commands.

The term “communication message” refers to a digital message, such as an email or text message, generated, confirmed, and sent based on user command information.

The system for implementing this invention comprises a server and a terminal device capable of being worn or carried by a user, such as smart glasses or a smart device with a camera, microphone, and speaker. The terminal includes software for audio recording, image capture, feature extraction, and communication with various application programming interfaces. The server possesses computing resources for processing data, performing emotion analysis, context-based decision-making, and interfacing with a generative artificial intelligence model.

The terminal acquires acoustic information from the user via a microphone. The terminal utilizes speech recognition software to convert the received audio data into command information, identifying the user's intent or request. For instance, if the user says, “Show me where the sticky notes are,” the terminal captures this as audio and processes it into a text command.

The terminal further analyzes acoustic feature information such as pitch, tone, speed, and volume using dedicated audio processing software. These features are sent along with the command information to an emotion analysis device, which may be implemented using a software API such as a cloud-based emotion recognition service. The server or terminal receives the output, estimating the user’s emotional state, e.g., “anxious” or “calm.”

Based on the estimated emotional state, the server employs a control device (logic implemented in software or hardware) to determine the appropriate strategy for providing guidance and information to the user. For example, if the user is perceived as frustrated, the server will select a simpler and more supportive instruction style.

Image information relevant to the user’s command is then acquired. The terminal activates its camera and captures one or more images of the surrounding environment, such as store shelves or signage. The terminal runs an optical character recognition process (for example, Tesseract OCR software) on the captured images and converts relevant image information into character information (text data).

The server uses position information, together with the extracted character information, to ascertain the user’s current location or the location of an item within the environment. For instance, the server may utilize indoor mapping APIs that are not tied to a specific provider.

Once location and context are determined, the terminal prepares a prompt sentence for the generative AI model. The generative AI model, which can be an advanced language model such as a commercially available cloud-based neural network processor, receives the prompt text and contextual information. The model generates guidance information, typically a set of clear and concise instructions for navigation or information retrieval.

A concrete example of a prompt sentence for the generative AI model is as follows:

Emotion API detected that the user is anxious. The user is currently looking for the location of sticky notes inside the store. Please generate navigation instructions that are clear and concise.

The terminal receives the output guidance information, such as:

Turn right, proceed to Aisle 3, and you will find the sticky notes on your right.

This guidance information is then converted into acoustic information with speech synthesis software, such as a text-to-speech API. The terminal delivers the synthesized audio output to the user via a speaker or earphone.

The system may also include means for transcribing or editing digital records and composing, confirming, and sending digital communication messages (such as emails or notifications) in accordance with the user's command information.

Through this embodiment, user experience and accessibility are improved, as the system dynamically adjusts the mode, style, and content of information provided to the user by recognizing the user's emotional state and environmental context. This approach enables visually impaired or other users to comfortably and efficiently navigate environments such as retail spaces by combining acoustic information processing, image acquisition and analysis, generative artificial intelligence modeling, and real-time adaptive feedback.

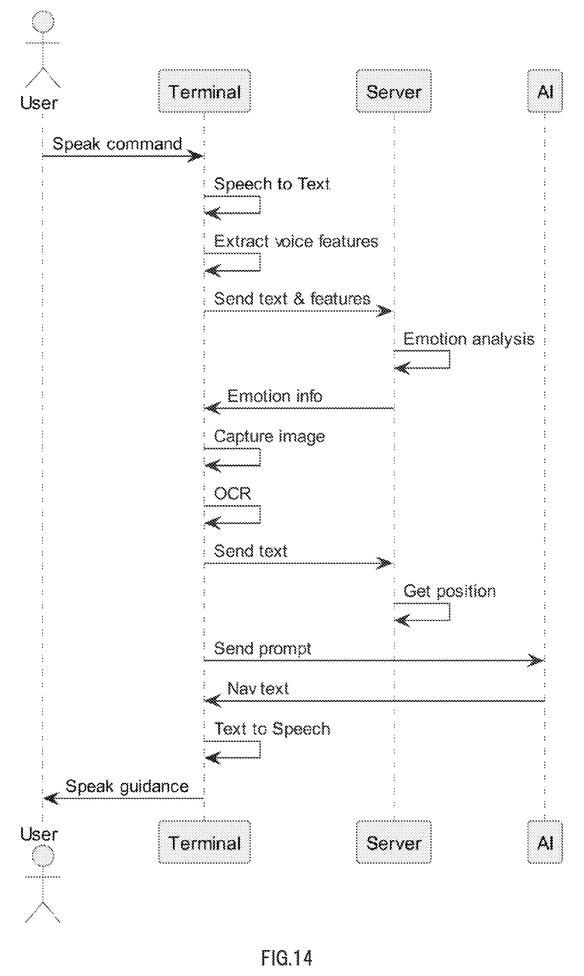

The following describes the processing flow using FIG. 14.

### Step 1:

The user wears the terminal device, such as smart glasses, and issues a spoken command, for example, "Show me where the sticky notes are."

Input: Spoken command from the user.

Output: Voice data captured by the microphone.

The user utters the command, and the terminal's microphone records the audio data.

### Step 2:

The terminal receives the captured audio data and processes it using speech recognition software to convert the voice data to text.

Input: Voice data.

Output: Text transcribed from the user's command.

The terminal sends the recorded audio to a speech-to-text engine, which analyzes the audio waves and outputs corresponding command text.

### Step 3:

The terminal analyzes the recorded voice data to extract acoustic features such as pitch, intonation, speed, and volume.

Input: Voice data.

Output: Acoustic feature data (e.g., pitch, speed, tone analysis, etc.).

The terminal uses audio processing algorithms to compute descriptive features that may indicate the user's emotional state.

### Step 4:

The terminal sends the transcribed command text and the extracted acoustic feature data to an emotion analysis device, which estimates the user’s emotional state.

Input: Command text and acoustic feature data.

Output: Emotional state information (e.g., "anxious", "calm", etc.).

The emotion analysis device processes the input and classifies the user’s state based on predefined models or machine learning algorithms.

### Step 5:

The terminal receives the emotional state information and determines if any adaptive behavior is required (such as simplifying instructions due to detected anxiety).

Input: Emotional state information.

Output: Adjustment parameters for information presentation style.

The terminal chooses an appropriate guidance strategy matching the user’s emotion.

### Step 6:

The terminal activates its camera to capture the environment, such as shelves or store signage, in response to the command.

Input: Control command to camera based on user intent.

Output: Captured image data.

The terminal directs the user, if necessary, to point the camera and captures an image relevant to the user’s request.

### Step 7:

The terminal processes the captured image using optical character recognition software to extract text information, such as labels or signboards.

Input: Captured image data.

Output: Extracted text data from the image.

The terminal runs an OCR algorithm, translating the visual content into readable textual information.

### Step 8:

The server uses the extracted text data and matches it to position information, such as in-store location, using environmental mapping software or local database lookup.

Input: Extracted text data from OCR.

Output: Position information or location coordinates.

The server correlates product or shelf names with the store’s digital map to determine the exact location.

### Step 9:

The terminal generates a prompt sentence using the emotional state, command text, and location information, and sends this prompt to a generative AI model.

Input: Emotional state information, command text, position information.

Output: Prompt sentence and query to generative AI model; generated guidance text.

The terminal creates a comprehensive request, such as:

"Emotion analysis detected that the user is anxious. The user is looking for sticky notes. The sticky notes are located at Aisle 3. Please generate clear, concise navigation instructions."

It sends this to the generative AI model, which returns customized instructions.

### Step 10:

The terminal receives the AI-generated guidance text and processes it with a text-to-speech engine to synthesize spoken instructions.

Input: Guidance text.

Output: Synthesized speech data.

The terminal converts the response, such as "Turn right, go straight to Aisle 3. Sticky notes are on your right," into audio output.

### Step 11:

The terminal outputs the synthesized speech through the terminal's speaker to the user.

Input: Synthesized speech data.

Output: Spoken guidance for the user.

The user hears the adaptive and context-aware navigation or information instructions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

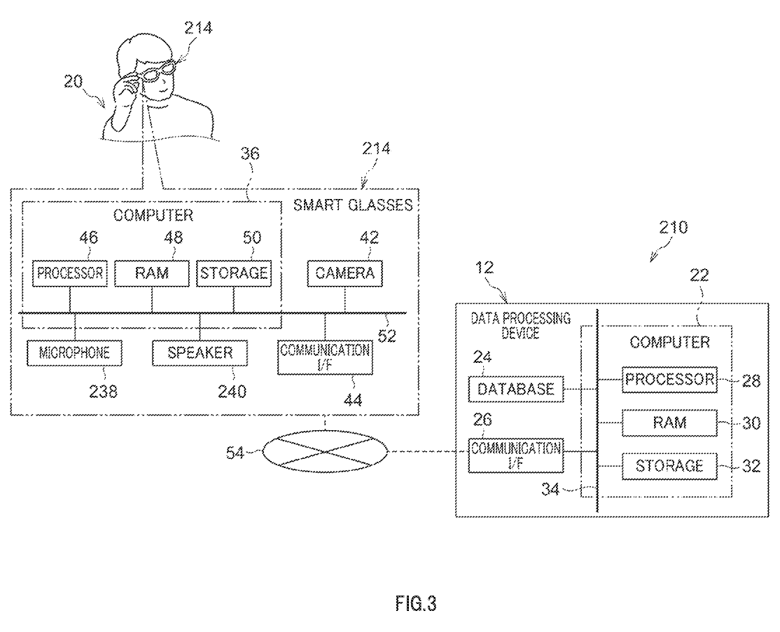

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

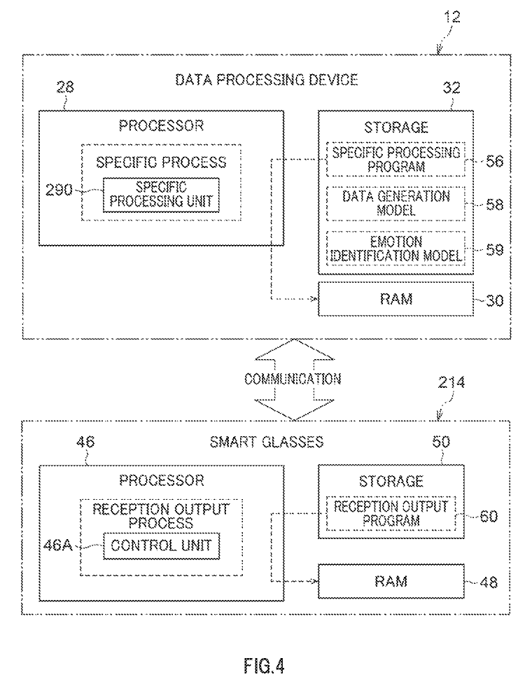

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

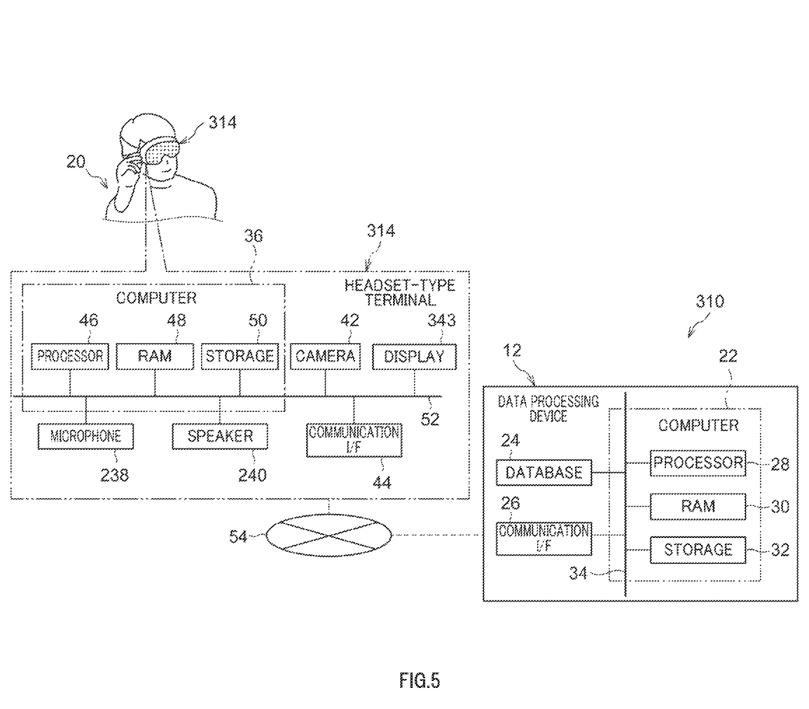

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

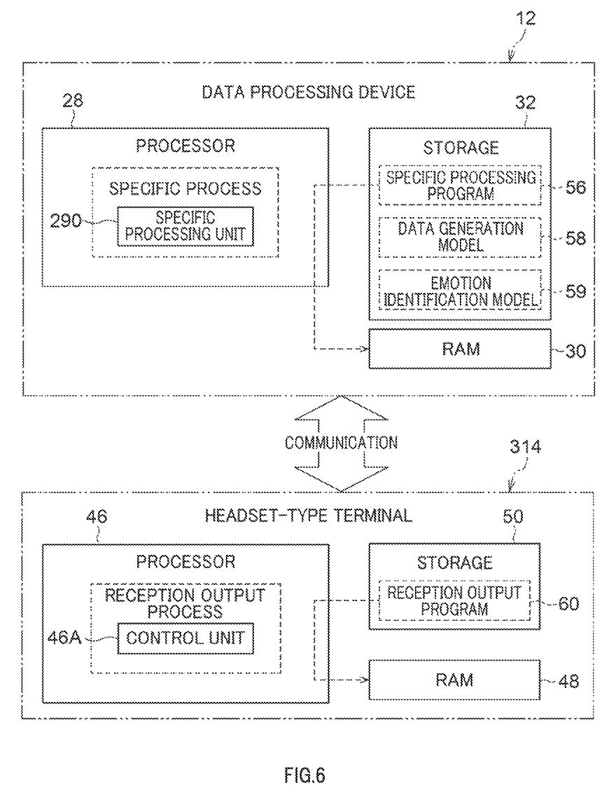

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

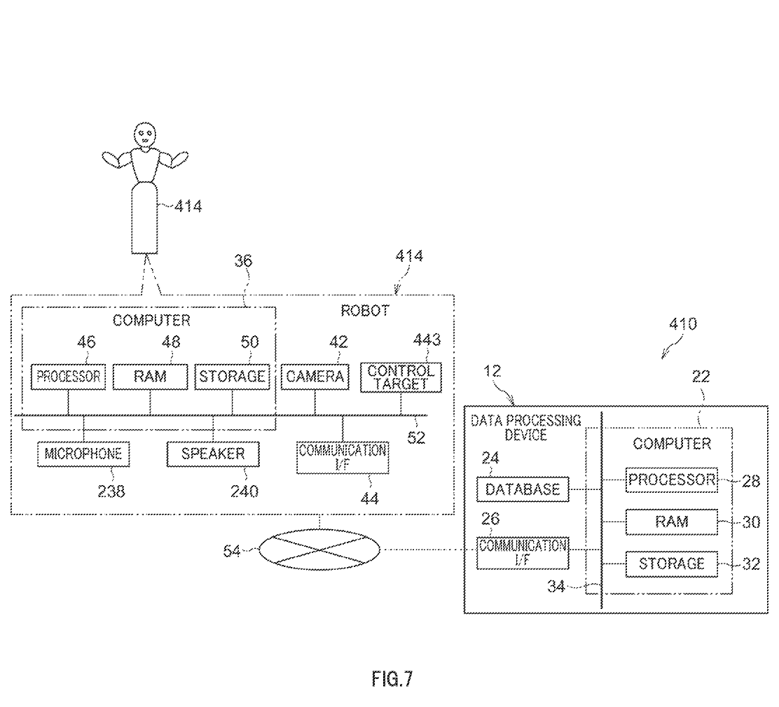

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

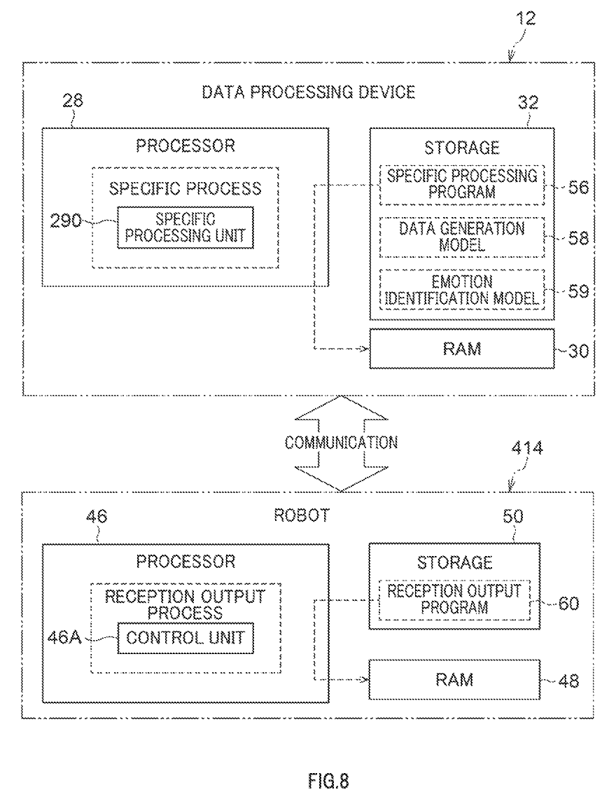

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

Example 1

Explanation of flow will be omitted due to being similar to a flow of the specific processing in Example 1 as described in the first exemplary embodiment above.

Application Example 1

Explanation of flow will be omitted due to being similar to a flow of the specific processing in Application Example 1 as described in the first exemplary embodiment above.

Example 2

Explanation of flow will be omitted due to being similar to a flow of the specific processing in Example 2 as described in the first exemplary embodiment above.

Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

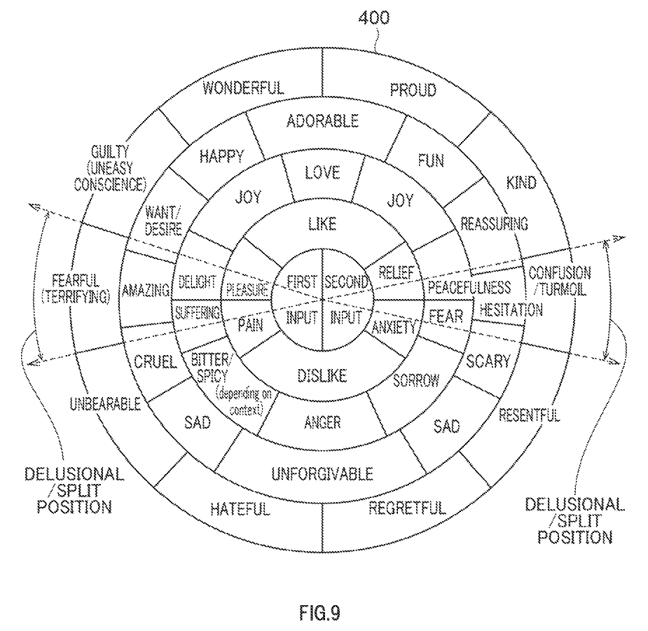

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

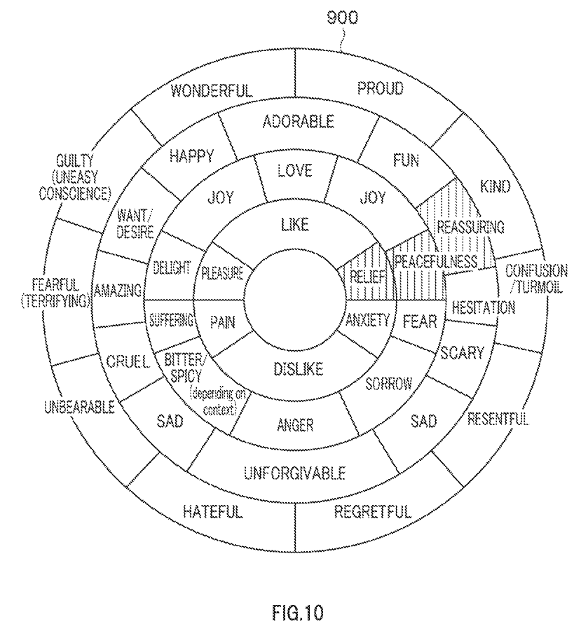

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

(Supplementary 1)

A system comprising a processor,

wherein the processor is configured to

acquire audio input information and convert the audio input information into digital information,

analyze the converted digital information to extract user instruction content,

acquire image information based on the instruction content and extract character information from the image information,

utilize a generative information processing model to perform extraction or editing of important information from the extracted character information by generating an input sentence for the generative information processing model, and

provide the extracted or edited information as audio output information.

(Supplementary 2)

The system according to supplementary 1,

wherein the processor is configured to

execute a control process to edit or transcribe the extracted or edited character information in accordance with the user instruction content included in the acquired audio input information.

(Supplementary 3)

The system according to supplementary 1,

wherein the processor is configured to

execute a control process to generate, confirm, and transmit communication information in accordance with the user instruction content included in the acquired audio input information.

Application Example 1

(Supplementary 1)

A system comprising a processor,

wherein the processor is configured to

acquire acoustic information,

convert the acquired acoustic information into linguistic information and interpret command content,

acquire information displayed on a visual display device based on the interpreted command content,

extract character information from the acquired display information using optical character recognition technology,

generate a prompt sentence for a natural language generation model based on the extracted character information and the command content,

input the generated prompt sentence into a generative artificial intelligence model to create summary information or edited information,

convert the generated summary information or edited information into acoustic information and provide the converted information to a user using an auditory output device,

estimate an emotional state of the user from the acoustic information,

and adjust the content or expression method of the summary information or edited information according to the estimated emotional state.

### (Supplementary 2)

The system according to supplementary 1,

wherein the processor is configured to

transcribe, copy, or edit a part or all of the character information to another recording area in accordance with the command content and the extracted character information.

### (Supplementary 3)

The system according to supplementary 1,

wherein the processor is configured to

execute creation, confirmation, and transmission processing of an electronic communication document based on the command content and the extracted character information.

### Example 2

(Supplementary 1)

A system comprising a processor,

wherein the processor is configured to

acquire acoustic information from a user;

convert the acquired acoustic information into character information using acoustic analysis technology;

analyze the command content from the converted character information;

acquire image information of display content of a display device according to the command content;

apply optical character recognition technology to the acquired image information to extract character information;

identify an emotional state of the user from the acquired acoustic information;

perform summarization or content editing of the extracted character information based on the identified emotional state by using a generative machine learning model; and

present the summarized or edited content to the user by means of an acoustic output device.

### (Supplementary 2)

The system according to supplementary 1,

wherein the processor is configured to perform transcription or content modification of the character information according to the user's command content based on the extracted character information and the identified emotional state.

### (Supplementary 3)

The system according to supplementary 1,

wherein the processor is configured to create, review, and transmit an electronic communication message based on the extracted character information and the identified emotional state.

### Application Example 2

(Supplementary 1)

A system comprising a processor,

wherein the processor is configured to

acquire acoustic information from a user,

analyze the acoustic information to generate command information,

estimate an emotional state based on the command information and acoustic feature information by an emotion analysis device,

adjust an information providing method according to the estimated emotional state using a control device,

acquire image information based on the command information,

convert the acquired image information into character information,

generate guidance information based on the converted character information and position information using a generative artificial intelligence model, and

provide the guidance information and guidance method as acoustic information to the user.

### (Supplementary 2)

The system according to supplementary 1,

wherein the processor is configured to

transcribe or edit electronic record information in accordance with the command information.

### (Supplementary 3)

The system according to supplementary 1,

wherein the processor is configured to

generate, confirm, and transmit a communication message based on the command information.

What is claimed is:

1. A system comprising a processor,
wherein the processor is configured to:
acquire a voice command from a user,
analyze the acquired voice command,
acquire screen information based on the analyzed voice command,
process the acquired screen information using a generative artificial intelligence model to summarize or edit the information, and
provide the summarized or edited information to the user as synthesized speech.

2. The system according to claim 1,
wherein the processor is further configured to transcribe or edit text in accordance with the user's instruction based on the acquired voice command.

3. The system according to claim 1,
wherein the processor is further configured to create, confirm, and send an email based on the acquired voice command.
